(19) United States
(12) Patent Application Publication
(10) Pub. No.: US 2019/0170154 A1
(43) Pub. Date: Jun. 6, 2019

(54) ASSEMBLY FOR REDUCING SIZE OF SUSPENDED SOLIDS

(71) Applicant: Weir Minerals Australia Ltd, Artarmon, New South Wales (AU)

(72) Inventors: Gareth Munro, Gooseberry Hill (AU); Cesar Calma, Penshurst (AU); Hugh Duong, Beverly Hills (AU); Nestor Cinotti, Elanora Heights (AU); Alvin Alurkumar, Granville (AU)

(73) Assignee: Weir Minerals Australia Ltd, Artarmon, New South Wales (AU)

(21) Appl. No.: 16/322,904

(22) PCT Filed: Aug. 1, 2017
(86) PCT No.: PCT/AU2017/050805

§ 371 Date: Feb. 1, 2019

(30) Foreign Application Priority Data
Aug. 1, 2016 (AU) 2016903022
Nov. 11, 2016 (AU) 2016904605

(51) Int. Cl. F04D 29/22; F04D 7/04

(52) U.S. Cl. CPC F04D 29/2288; B01F 7/0075; F04D 29/2222; F04D 7/045

(57) ABSTRACT

An assembly for reducing the size of suspended solids in a pump intake including a rotatable element and a screen configured to locate in a position between a pump and the rotatable element.

### TECHNICAL FIELD

The present invention generally relates to an assembly for reducing the size of suspended solids upstream of a pump impeller.

### BACKGROUND

Pumps are often required to transfer a fluid that contains suspended solids. Such suspended solids may include scale that can build up on pipes or within process vessels, where they may dislodge and become suspended in a fluid stream in a pump suction. The presence of such suspended solids in the suction line of a pump may be problematic in that they may become clogged in a pump impeller or volute and may reduce the net positive suction head and reduce the efficiency of pumping operations. In particular, oversized suspended solids may cause blockages and may damage parts of a pump such as the pump impeller.

In some applications, a strainer or a filter may be used to remove or reduce large suspended solids in a fluid stream upstream of a pump. Such strainers or filters may become blocked, leading to a drop-off in pump performance, such that the pump and associated piping and processes may need to be shut down and isolated so that the strainer or filter may be removed and cleaned. For fluid streams carrying a heavy burden of suspended solids, the strainers or filters may require frequent cleaning leading to severe disruption of the pump operation.

Accordingly, it would be desirable for a system to remove or reduce large suspended solids upstream of a pump in a manner that minimizes interference with the operation of the pump.

The reference in this specification to any prior publication (or information derived from it), or to any matter which is known, is not, and should not be taken as, an acknowledgement or admission or any form of suggestion that prior publication (or information derived from it) or known matter forms part of the common general knowledge in the field of endeavour to which this specification relates.

### BRIEF SUMMARY

The present invention seeks to provide an invention with improved features and properties.

In a first aspect the present invention provides an assembly for reducing the size of suspended solids in a pump intake including a rotatable element and a screen configured to locate in a position between a pump and the rotatable element.

In an embodiment, the rotatable element may be rotated in a forward direction about a rotation axis, the rotatable element including two arm members extending generally radially from a central hub of the rotating element in generally opposing radial directions, wherein each arm member includes opposed upstream and downstream sides, each arm member further including a leading side facing the forward direction and an opposed trailing side facing a rearward direction, wherein the leading side is configured with a curvature along a radial direction of the leading side such that the leading side curves inwardly towards the trailing side.

In an embodiment, the trailing side is configured with a curvature along a radial direction of the trailing side such that the trailing side curves outwardly from the leading side.

In a second aspect the present invention provides the rotatable element is rotatable in a forward direction about a rotation axis X-X, the rotatable element including two or more arm members extending generally radially from the rotation axis, each arm member including a leading side facing in the forward direction, the leading side having a peripheral edge distal from the rotation axis; and, a trailing side facing in a rearward direction, the trailing side having a peripheral edge distal from the rotation axis, wherein the leading side is configured with a curvature relative to the radial extension of the arm member such that the leading side is generally concave relative to a radial line Y-Y extending from the rotation axis X-X through the peripheral edge of the trailing side.

In an embodiment the trailing side is configured with a curvature relative to the radial extension of the arm member such that the trailing side is generally convex relative to a radial line Z-Z extending from the rotation axis X-X through the peripheral edge of the leading side.

In an embodiment, the curvature of the leading side is continuous from a region proximal to the central hub to a region distal from the central hub.

In an embodiment, the leading side includes a chamfered surface proximal to the downstream side and a forward surface proximal to the upstream side, wherein the chamfered surface is configured to incline towards the trailing side.

In an embodiment, the chamfered surface is configured to incline towards the trailing side at an angle of between about 40° and about 60°.

In an embodiment, the forward surface is substantially normal to the forward direction.

In an embodiment, the trailing side includes a rounded surface proximal to the upstream side and a rearward surface proximal to the downstream side.

In an embodiment the rearward surface is substantially normal to the forward direction.

In an embodiment the rounded surface is configured with a curvature smoothly transitioning between the rearward surface and the upstream surface such that the rounded surface encompasses an edge of the trailing side proximal to the upstream side.

In an embodiment the rounded surface is configured with a curvature that is generally shaped as a circular arc.

In an embodiment the rounded surface comprises approximately one third of the thickness of the trailing side as measured between the upstream side and the downstream side.

In an embodiment the screen is configured with apertures and wherein the apertures are size to resist the passage therethrough of suspended solids above a maximum size.

In an embodiment the screen is configured with a shroud attached to a perimeter of the screen, and wherein the shroud is adapted to seat within an inner dimeter of a pump intake.

In an embodiment the screen comprises a plurality of ribs interconnected to form a network thereby defining a plurality of apertures, wherein the network includes a plurality of junctions formed by at least two ribs meeting at an obtuse angle.

In an embodiment, the network comprises interconnected axial arrays of ribs, the network extending between an internal support and an external support, wherein the plurality of ribs are arranged into: a first axial array of ribs connected to and arranged around an external perimeter of the internal support; and, a final axial array of ribs connected to and arranged around an internal perimeter of the external support.

In an embodiment, the arrangement of the plurality of ribs further includes one or more further axial arrays or ribs arranged successively at an increasing radial distance from the first axial array,

In an embodiment, the internal support is configured in the shape of a ring defining a central aperture therethrough, wherein the central aperture is configured to receive a rotating shaft.

In an embodiment, the internal support is configured in the shape of a star defining a central aperture therethrough, wherein the central aperture is configured to receive a rotating shaft.

In an embodiment, the profile of the ribs have a region of maximum thickness between an upstream periphery and a downstream periphery of the ribs.

In an embodiment, the thickness of the ribs taper from the region of maximum thickness to the upstream periphery.

In an embodiment, the thickness of the ribs taper from the region of maximum thickness to the downstream periphery.

In an embodiment, the region of maximum thickness occurs at approximately 15% to 25% of the distance between the upstream periphery and the downstream periphery.

In an embodiment, the region of maximum thickness occurs at approximately 20% of the distance between the upstream periphery and the downstream periphery.

According to a third aspect, the present invention provides an apparatus for reducing the size of suspended solids upstream of a pump impeller wherein the apparatus may be rotated in a forward direction about a rotation axis, the apparatus including two arm members extending generally radially from a central hub of the apparatus in generally opposite radial directions, wherein each arm member includes opposed upstream and downstream sides, each arm member further including a leading side facing the forward direction and an opposed trailing side facing a rearward direction, wherein the leading side is configured with a curvature along a radial direction of the leading side such that the leading side curves inwardly towards the trailing side.

In an embodiment the trailing side is configured with a curvature along a radial direction of the trailing side such that the trailing side curves outwardly from the leading side.

According to a fourth aspect the present invention provides an apparatus for reducing the size of suspended solids upstream of a pump impeller which can be rotated in a forward direction about a rotation axis X-X, the apparatus including two or more arm members extending generally radially from the rotation axis, each arm member including a leading side facing in the forward direction, the leading side having a peripheral edge distal from the rotation axis; and, a trailing side facing in a rearward direction, the trailing side having a peripheral edge distal from the rotation axis, wherein the leading side is configured with a curvature relative to the radial extension of the arm member such that the leading side is generally concave relative to a radial line Y-Y extending from the rotation axis X-X through the peripheral edge of the trailing side.

In an embodiment the trailing side is configured with a curvature relative to the radial extension of the arm member such that the trailing side is generally convex relative to a radial line Z-Z extending from the rotation axis X-X through the peripheral edge of the leading side.

In an embodiment the curvature of the leading side is continuous from a region proximal to the central hub to a region distal from the central hub.

In an embodiment the leading side includes a chamfered surface proximal to the downstream side and a forward surface proximal to the upstream side, wherein the chamfered surface is configured to incline towards the trailing side.

In an embodiment the chamfered surface is configured to incline towards the trailing side at an angle of between about 40° and about 60°.

In an embodiment the forward surface is substantially normal to the forward direction.

In an embodiment the trailing side includes a rounded surface proximal to the upstream side and a rearward surface proximal to the downstream side.

In an embodiment the rearward surface is substantially normal to the forward direction.

In an embodiment the rounded surface is configured with a curvature smoothly transitioning between the rearward surface and the upstream surface such that the rounded surface encompasses an edge of the trailing side proximal to the upstream side.

In an embodiment the rounded surface is configured with a curvature that is generally shaped as a circular arc.

In an embodiment the rounded surface comprises approximately one third of the thickness of the trailing side as measured between the upstream side and the downstream side.

According to a fifth aspect the present invention provides an assembly for reducing the size of suspended incident on a pump impeller, including the apparatus according to any one of the preceding aspects; and, a screen located between the apparatus and the pump impeller, wherein the screen is configured with apertures and wherein the apertures are size to resist the passage therethrough of suspended solids above a maximum size.

In an embodiment the screen is configured with a shroud attached to a perimeter of the screen, and wherein the shroud is adapted to seat within an inner dimeter of a pump intake.

In a sixth aspect the present invention provides a screen for a pump inlet comprising a plurality of ribs interconnected to form a network thereby defining a plurality of apertures, wherein the network includes a plurality of junctions formed by at least two ribs meeting at an obtuse angle.

In an embodiment the network comprises interconnected axial arrays of ribs, the network extending between an internal support and an external support, wherein the plurality of ribs are arranged into: a first axial array of ribs connected to and arranged around an external perimeter of the internal support; and, a final axial array of ribs connected to and arranged around an internal perimeter of the external support.

In an embodiment the arrangement of the plurality of ribs further includes one or more further axial arrays or ribs arranged successively at an increasing radial distance from the first axial array.

In an embodiment the internal support is configured in the shape of a ring defining a central aperture therethrough, wherein the central aperture is configured to receive a rotating shaft.

In an embodiment the internal support is configured in the shape of a star defining a central aperture therethrough, wherein the central aperture is configured to receive a rotating shaft.

In an embodiment the profile of the ribs have a region of maximum thickness between an upstream periphery and a downstream periphery of the ribs.

In an embodiment the thickness of the ribs taper from the region of maximum thickness to the upstream periphery.

In an embodiment the thickness of the ribs taper from the region of maximum thickness to the downstream periphery.

In an embodiment the region of maximum thickness occurs at approximately 15% to 25% of the distance between the upstream periphery and the downstream periphery.

In an embodiment the region of maximum thickness occurs at approximately 20% of the distance between the upstream periphery and the downstream periphery.

In a seventh aspect the present invention provides a kit comprising the rotatable element of an above aspect and the screen according to an above aspect.

### BRIEF DESCRIPTION OF FIGURES

Example embodiments should become apparent from the following description, which is given by way of example only, of at least one preferred but non-limiting embodiment, described in connection with the accompanying figures.

FIG. 1 illustrates a cutaway view of a pump fitted with an embodiment of an assembly of the present invention;

FIG. 2 illustrates a top view of an embodiment of a rotatable element;

FIG. 3 illustrates a perspective view of the rotatable element of FIG. 2;

FIG. 4 illustrates an alternative perspective view of the rotatable element of FIG. 1;

FIG. 5 illustrates a side view of the rotatable element of FIG. 1;

FIG. 6 illustrates a screen as known to the prior art;

FIG. 7 illustrates a front view of an embodiment of a screen according to the present invention;

FIG. 8a illustrates the embodiment of FIG. 7 with highlighted areas and a section line.

FIG. 8b illustrates a view of a highlighted area of FIG. 8a;

FIG. 8c illustrates a view of a highlighted area of FIG. 8a;

FIG. 9 illustrates a cut-away view along the section line of FIG. 7;

FIG. 10 illustrates a front perspective view of the screen of FIG. 7;

FIG. 11 illustrates a rear perspective view of the screen of FIG. 7;

FIG. 12 illustrates a side view of the screen of FIG. 7;

FIG. 13 illustrates a front view of an embodiment of a screen according to the present invention with a section line;

FIG. 14 illustrates a cut-away view along the section line of FIG. 13;

FIG. 15 illustrates a front perspective view of the screen of FIG. 13;

FIG. 16 illustrates a rear perspective view of the screen of FIG. 13;

FIG. 17 illustrates a side view of the screen of FIG. 13;

FIG. 18 illustrates a view of an embodiment of a network of a screen according to the present invention;

FIG. 19 illustrates a schematic view of the open area of the screen of FIG. 1;

FIG. 20 illustrates a schematic view of the open area of the screen of FIG. 13;

FIG. 21 illustrates a view of a cross-sectioned junction of a screen of the prior art;

FIG. 22 illustrates a T-shaped junction of a screen of the prior art;

FIG. 23 illustrates a view of a junction according to an embodiment of the present invention;

FIG. 24 illustrates a schematic cut-away view of a screen according to the present invention in profile;

FIG. 25 illustrates a schematic cut-away view of a screen and a rotatable element according to the present invention in profile;

FIG. 26 illustrates a cross sectional view of an embodiment of a rib according to the present invention;

FIG. 27 illustrates a front view of an embodiment of an assembly according to the present invention with a section line;

FIG. 28 illustrates a cut-away view along the section line of FIG. 27;

FIG. 29 illustrates a front perspective view of the assembly of FIG. 27;

FIG. 30 illustrates a rear perspective view of the assembly of FIG. 27;

FIG. 31 illustrates a rear view of the assembly of FIG. 27;

FIG. 32 illustrates a side view of the assembly of FIG. 27.

### PREFERRED EMBODIMENTS

The following modes, given by way of example only, are described in order to provide a more precise understanding of the subject matter of a preferred embodiment or embodiments.

In the Figures, incorporated to illustrate features of an example embodiment, like reference numerals are used to identify like parts throughout the Figures.

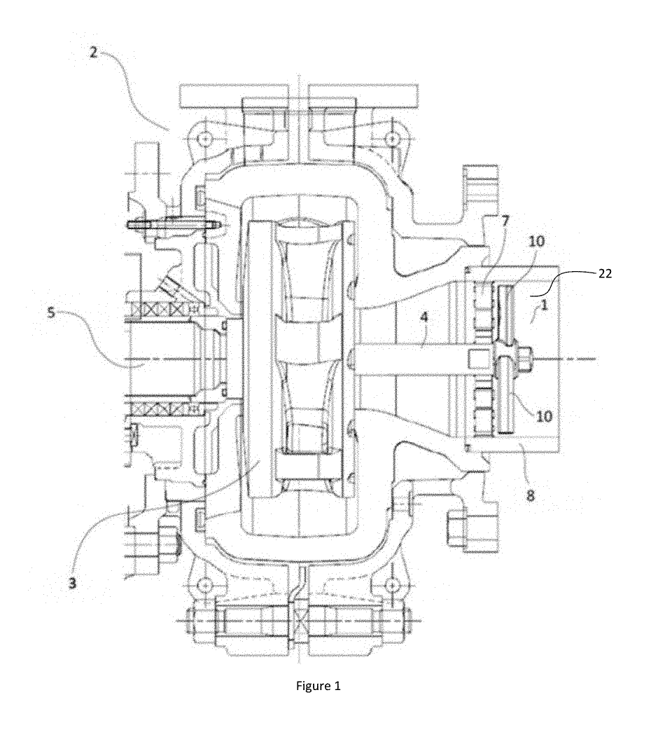

Referring to the FIG. 1, shown is an assembly 22 for reducing the size of suspended solids 41 upstream of a pump impeller 3. The assembly 22 may be locatable in a pump 2 intake. The assembly 22 may include a rotatable element 1 configured to locate in an upstream position relative to a screen 7. By this arrangement, the rotatable element 1 may rotate in order to break up suspended solids 41 such as scale into smaller pieces before flowing to the pump impeller 3. Also by this arrangement, the screen 7 may act to prevent the throughflow of suspended solids 41 above a maximum size. Further, the rotatable element 1 may be positioned in close proximity to the screen 7 such that suspended solids above a maximum size caught on the surface of the screen 7 may be ground down into a smaller size by attrition due to contact with the rotating rotatable element 1.

FIG. 1 shows a section view of a pump 2 fitted with the assembly 22. The assembly 22 is located in the pump 2 intake upstream of the pump impeller 3. The rotatable element 1 may be mounted to a shaft 4 that is appended to a main shaft 5 driving the pump impeller 3. By this arrangement the rotating element 1 may be rotated at the same speed as the main shaft 5 and pump impeller 3. The rotatable element 1 may be located upstream of a screen 7 configured to prevent the through flow of suspended solids 41 above a maximum size. Otherwise stated, a screen 7 may be located between the rotatable element 1 and the pump impeller 3. The location of the rotatable element 1 may be offset from the location of the screen 7 by a relatively small distance such that suspended solids 41 above a maximum size may only build-up on the surface of the screen by a relatively small amount before they contact with the rotatable element 1. By this arrangement, the rotatable element 1 may grind down suspended solids 41 built-up on the surface of the screen 7, thereby minimizing blockages of the screen 7 by oversized solids 41 that were not sufficiently reduced in size when flowing past the rotatable element 1.

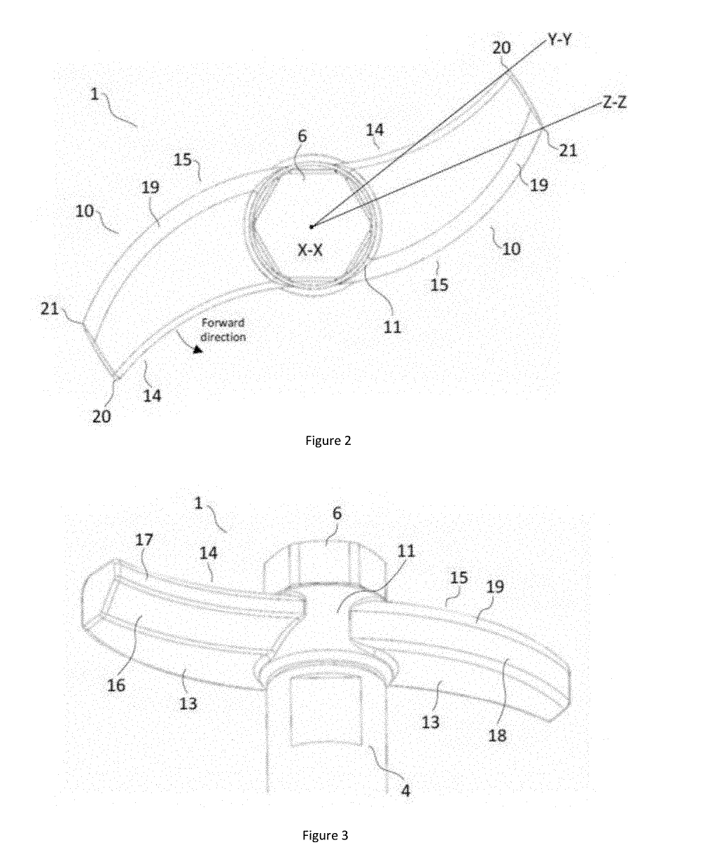

Referring to FIGS. 2 to 5, shown is a rotatable element 1 for reducing the size of suspended solids 41 upstream of a pump impeller 3. The rotatable element 1 may be configured to be rotated in a forward direction about a rotation axis. The rotation axis may be shared by the pump impeller 3. The rotatable element 1 may include two arm members 10 extending generally radially from the axis of rotation. By this arrangement, the rotating arm members 10 may come in contact with solids suspended in a fluid flowing toward the pump impeller 3, and may thereby break the suspended solids 41 into a smaller size before the solids reach the pump impeller 3.

Referring to FIG. 2, shown is an embodiment of a rotatable element 1 for reducing the size of suspended solids upstream of a pump impeller 3. The rotatable element 1 includes two arm members 10 that extend from a central hub 11 in a generally radial direction. The central hub 11 may be in engagement to a rotatable shaft 4, thereby defining an axis of rotation. The direction by which the arm members 10 travel about the rotation axis may be termed the forward direction. The arms members 10 may be generally elongate in the radial direction and may join with the central hub 11 at opposing radial directions. In some embodiments, the rotatable element 1 may include three or more arm members 10, with each arm member 10 extending in a generally radial direction from the central hub 11 and wherein each arm member 10 is joined to the central hub 11 at equal or approximately equal intervals about the central hub 11.

The arm members 10 may have opposed leading sides 14 and trailing sides 15. The leading side 14 is the side of the arm member 10 facing in the forward direction of rotation and the trailing side 15 is side of the arm member 10 facing in a rearward direction that is opposite to the forward direction. The leading side 14 and the trailing side 15 may be offset from each other by a distance such that the arm member 10 is configured with a thickness in the direction of rotation. The thickness between the leading side 14 and the trailing side 15 may taper away from the central hub 11.

The arm members 10 may have opposed upstream sides 12 and downstream sides 13. The upstream side 12 is that facing the upstream direction of a pump suction intake when the rotatable element 1 is in use. The downstream 13 side is that nearest to the pump impeller 3 when the rotatable element 1 is in use, according to the usual conventions of describing the direction of fluid flowing in a pipe.

Although the arm members 10 extend generally radially from the central hub 11 and hence the axis of rotation, the arms are configured with a curvature such that they are swept towards the forward direction. FIG. 1 shows a top view of the rotatable element 1 from an upstream position, looking towards a downstream position where a pump impeller 3 may be located in normal use of the rotatable element 1; in this view, the arm member 10 may be considered to take the general form of a cubic curve, with an inflection in the region of the central hub 11/rotation axis, and with each of the arm members 10 curving toward the forward direction of rotation. As depicted in FIG. 1, both the leading side 14 and the trailing side 15 of the arm members 10 curve forwardly, such that both the leading side 14 and the trailing side 15 curve forwardly in the forward direction of rotation.

Otherwise stated, the leading side 14 may be configured with a curvature along the radial extension of the arm member 10 such that the leading side 14 curves inwardly towards the trailing side 15. The trailing side 15 may also be configured with a curvature along the radial extension of the arm members 10 such that the trailing side 15 curves outwardly from the leading side 14. The forward sweep/curvature of the arm members 10 is such that portion of the arm members 10 distal from the central hub 11 may be forwardly positioned compared to the portion of the arm members 10 proximal to the central hub 11, relative to the forward direction.

As shown in FIG. 2, the curvature of the leading side 14 may be configured such that the leading side 14 is generally concave relative to a radial line Y-Y extending from the rotation axis X-X through a peripheral edge 21 of the trailing side 15. The curvature of the trailing side 15 may be configured such that the trailing side 15 is generally convex relative to a radial line Z-Z extending from the rotation axis X-X through a peripheral edge 20 of the leading side 14.

By this arrangement, portions of the leading side 14 distal from the central hub 11 may be in advance of portions of the leading side 14 proximal to the central hub 11 relative to the forward direction, such that solids flowing past the rotatable element 1, and solids coming into contact with the leading side 14 of the rotating arm members 10, may be encouraged toward the rotation axis. In comparison, if the arm members 10 did not display such curvature of the leading side 14, such as substantially straight arm members or backwardly curving arm memebers, the centrifugal force generated by the rotation of the arm members 10 may encourage solids 41 to agitate away from the rotation axis. Accordingly, the forward curvature of the arm members 10 may act to counteract the centrifugal force generated by the rotating arm members 10 such that solids 41 may be encouraged to agitate toward the rotation axis rather than being encouraged to agitate distally from the rotation axis.

In some embodiments, such as that shown in FIG. 1, the forward curvature of the leading side 14 along the radial direction may be continuous, such that leading side 14 curves smoothly and continuously from the central hub 11 to the peripheral edge 20 of the leading side 14 and such that the peripheral edge 20 of the leading side 14 is in advance of the region of the leading side 14 proximal to the central hub 11 relative to the forward direction of rotation. The curvature of the trailing side 15 may also be continuous from the junction region of the arm member 10 and central hub 11 to the peripheral edge 21 of the trailing side 15.

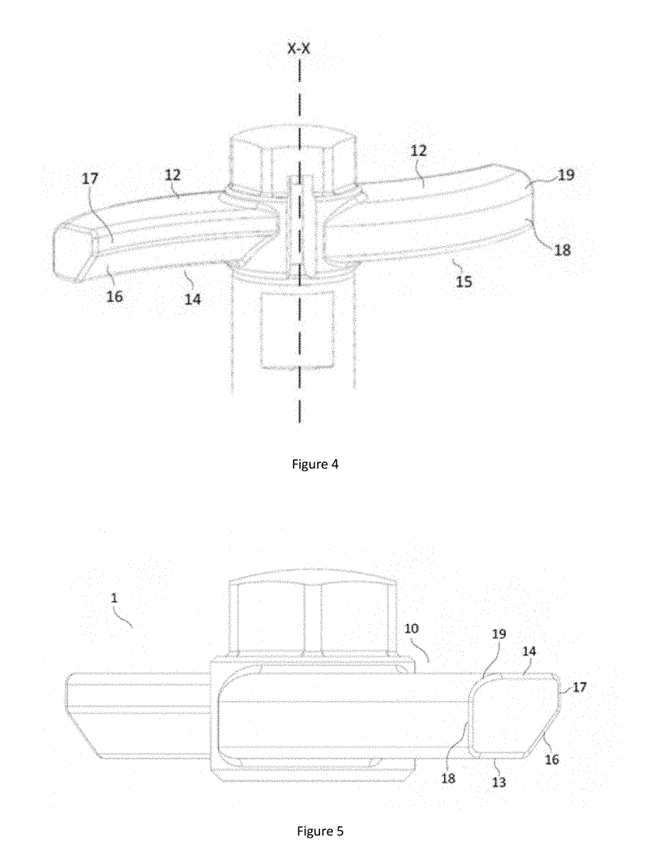

Referring now to FIGS. 3 and 4, shown are perspective views of the rotatable element 1 including showing the leading side 14 and the trailing side 15. The leading side 14 may be configured with a forward surface 17 and a chamfered surface 16. The forward surface 17 and chamfered surface 16 may both substantially extend along the entire span of the leading side 14 and the forward surface 17 and chamfered surface 16 may be adjacent to each other and may further be generally parallel to each other. The forward surface 17 may be proximal to the upstream side 12 and the chamfered surface 16 may be proximal to the downstream side 13. Transitions/edges between the upstream side 12 and the forward surface 17, the forward surface 17 and the chamfered surface 16, and the chamfered surface 16 and the down stream side 13, as well as other transitions/edges between surfaces/sides, may be smooth and rounded to some degree as depicted, or may alternatively be sharp.

The forward surface 17 is so called as it is in advance of the chamfered surface 16 relative to the forward direction. The forward surface 17 may be normal to the forward direction or substantially normal to the forward direction. The forward surface 17 may also be at right angles or approximately at right angles to the upstream 12 and/or downstream sides 13. The forward surface 17 may be orientated parallel or substantially parallel to the axis of rotation. By this arrangement, the forward surface 17 may pose a blunt surface relative to the flow of suspended solids towards a pump impeller 3, which may facilitate effective impact between the forward surface 17 and the suspended solids 41 flowing past for reducing the size of the suspended solids 41.

The chamfered surface 16 is so called as it is configured in the form of an angled or chamfered edge between the forward surface 17 and the downstream side 13. Otherwise stated, the chamfered surface 16 is configured to recede towards the downstream side 13, such that the chamfered surface 16 is inclined away from the forward surface 17 towards the downstream side 13. The angle at which the chamfered surface 16 recedes from the forward surface 17 may be between about 40° to about 60°. The angle at which the chamfered surface 16 recedes from the forward surface 17 may be about 45° to about 55° or about 50°. Otherwise stated, the chamfered surface 16 may be configured with an angle with respect to the axis of rotation of between about 40° to about 60°, between about 45° to about 55°, or about 50°.

The upstream side 12 and the downstream side 13 may be offset from each other such that the arm members 10 have a thickness in the direction of the rotation axis. Otherwise stated, the arm members 10 have a thickness in the superficial direction of fluid flow towards the pump impeller 3 when the rotatable element 1 is in use. Accordingly, the leading side 14 and trailing side 15 also have a thickness in this direction. In the embodiments of the Figures, the thickness of the forward surface 17 measured between the upstream side 12 and the downstream side 13 is about one third of the thickness of the leading side 14. Similarly, the thickness of the chamfered surface 16 may be about two thirds of the distance between the upstream side 12 and the downstream side 13. By this arrangement, the leading side 14 may have a relatively stream-lined profile in comparison with the trailing side 15, with a prominent forward surface 17 and a receding chamfered surface 16. This streamlined arrangement may improve the breaking action of the forward surface 17 on suspended solids during rotation of the arm members 10. Furthermore, the receding angle of the chamfered surface 16 may enhance the flow of fluid containing suspended solids 41 towards the impeller 3 such that flow is induced towards the pump impeller 3 thereby potentially lowering the required net positive suction head of the pump 2. Although the depicted embodiment has a forward surface 17 thickness of about one third of the leading side 14 and a chamfered surface 16 thickness of about two thirds of the leading side 14, other thicknesses of the forward surface 17 and the chamfered surface 16 are possible. For example, the forward surface 17 may be configured with a thickness of up to one half of the thickness of the leading side 14 or greater than one half of the thickness of the leading side 14, with the remainder of the thickness of the leading side 14 being substantially occupied by the chamfered surface 16.

The trailing side 15 may be configured with a rearward surface 18 and a rounded surface 19. The rearward surface 18 and the rounded surface 19 may both substantially extend along the entire span of the trailing side 15 and the rearward surface 18 and the rounded surface 19 may be adjacent to each other and may further be generally parallel to each other along the radial direction of the arm member 10. The rounded surface 19 may be proximal to the upstream side 12 and the rearward surface 18 may be proximal to the downstream side 13.

The rearward surface 18 is so called as it is generally positioned behind the rounded surface 19 relative to the forward direction of rotation. The rearward surface 18 may be normal to the forward direction of rotation or substantially normal to the forward direction of rotation. The rearward surface 18 may also be at right angles or approximately at right angles to the upstream and/or downstream sides 13. The rearward surface 18 may be orientated parallel or substantially parallel to the axis of rotation. The rearward surface 18 may be in parallel or substantially parallel orientation with respect to the forward surface 17.

The rounded surface 19 is so called as it is configured with a curvature that transitions from an edge of the rearward surface 18 to an edge of the upstream side 12. Otherwise stated an edge of the trailing side 15 adjacent to the upstream side 12 may be rounded to form the rounded surface 19. In the embodiment of the figures, the thickness of the rounded surface 19 measured between the upstream surface and the downstream surface may be about one third of the thickness of the trailing side 15. Similarly, the thickness of the rearward surface 18 may be about two thirds of the distance of between the upstream side 12 and the downstream side 13. The rounded surface 19 may be configured with a curvature in the form of a circular arc. In some embodiments, the radius of curvature of the rounded surface 19 may be about 5 mm, though other embodiments are equally permissible and may depend on the size of the rotating element 1. The curvature of the rounded surface 19 may induce a low pressure zone as the arms of the rotatable element 1 are rotated, such that a pressure differential is induced to encourage flow of fluid towards the pump impeller 3. By this arrangement, the rounded surface 19 may enhance the flow of fluid towards a pump intake and lower the required net positive suction head of the pump 2.

Although the embodiment of the Figures has a rounded surface 19 thickness of about one third of the overall thickness of the trailing side 15 as measured between the upstream surface 12 and downstream surface 13, other relative thicknesses of the rounded surface 19 are possible. For example, the rounded surface 19 may be configured with a thickness of up to about one half of the thickness of the trailing side 15, or greater than one half of the thickness of the trailing side 15, with the remainder of the thickness of the trailing side 15 being substantially occupied by the rearward surface 18.

The central hub 11 may be configured with an internal thread configured for attachment with a corresponding thread on a shaft 4. The internal thread may expend through the central hub 11 such that the central hub 11 is in a socket style configuration. By this arrangement, when the rotatable element 1 is threaded onto the shaft 4, a portion of the thread of the shaft 4 may emerge from the central hub 11, thereby allowing a locking nut 6 to be threaded onto the shaft 4 to maintain the rotatable element 1 in place on the shaft 4 at the rotatable element 1 rotates. In some embodiments, the locking 6 nut may be integral with the rotatable element 1.

Referring now to FIG. 5, shown is a side view of the rotatable element 1. The view show an end side of the arm members 10 distal from the rotation axis showing the profile of the leading side 14 including the forward surface 17 and the chamfered surface 16, as well as the trailing side 15 including the rearward surface 18 and the rounded surface 19. This view also shows the profile of the upstream and downstream sides 13. The profile of the end side is similar in relative proportions to a cross section of the arm member 10 taken along the forward direction of rotation, noting that the distance/thickness between the leading surface and the trailing surface decreases distally in the radial direction of the arm member 10 in the depicted embodiment, as is visible in FIG. 1.

The rotatable element 1 herein described may cause the reduction of size of suspended solids upstream of a pump impeller 3 with several surprising benefits. The forward curvature of the arm members 10 may increase the strength and wear performance compared to arm members 10 that radially extend without curvature. Furthermore, the forwardly curved blades may encourage agitation of suspended solids towards the center of a screen 7 located downstream of the rotatable element 1 which may result in lower torque requirements for the arm members 10 and reduced power consumption. The relatively streamlined forward surface 17 may improve the breaking action on suspended solids during rotation, whilst the chamfered surface 16 and the rounded surface 19 may enhance fluid flow past the rotatable element 1 and may reduce the required net positive suction head of the pump 2.

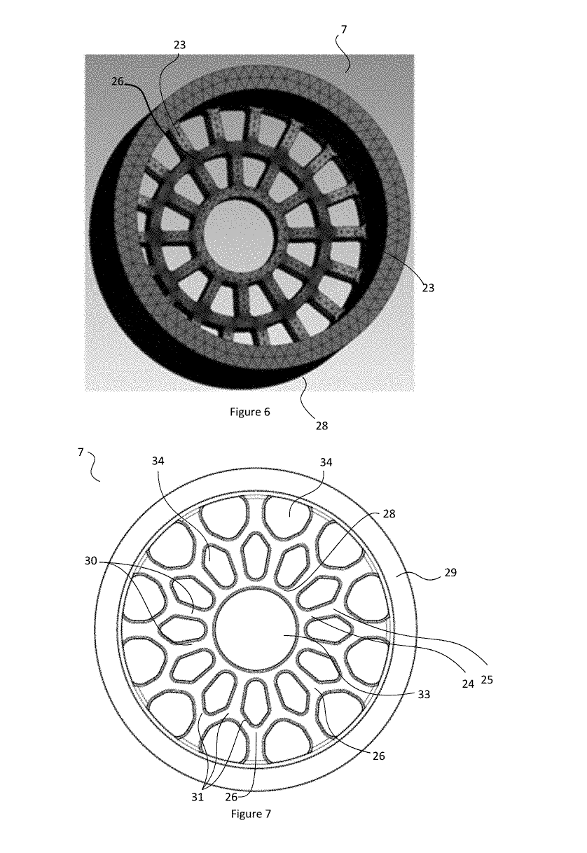

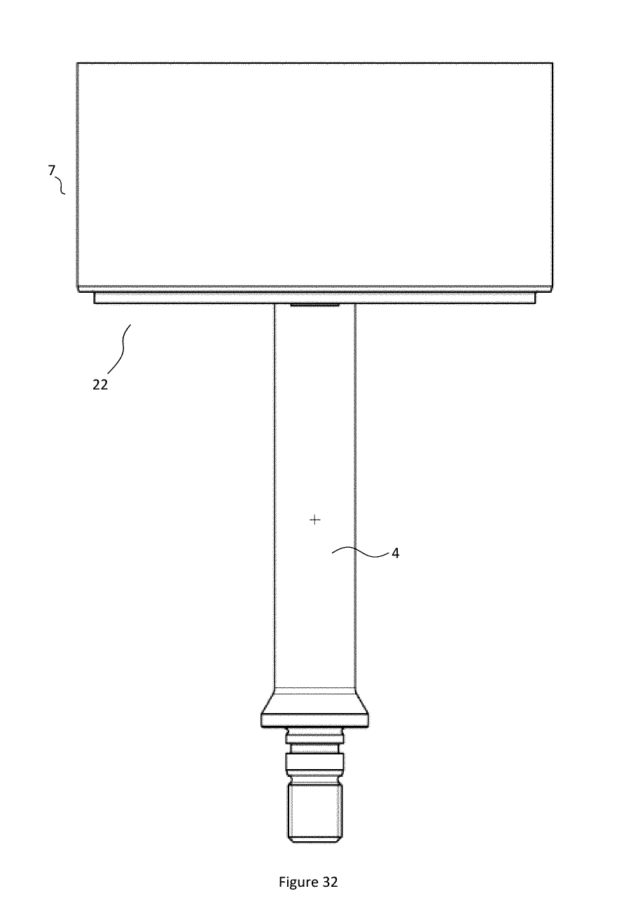

Described herein with reference to the FIGS. 6 to 32, shown are embodiments of a screen 7 adapted for placement in a pump 2 inlet upstream of a pump impeller 3. The screen may be configured as part of an assembly 22 for reducing the size of suspended solids upstream of a pump impeller 3, which may include the rotating element 1 The screen 7 is configured to reduce the through passage of solids above a certain size, thereby reducing the incidence of solids above a certain size flowing into a pump. The screen 7 is formed of a plurality of ribs 23, which are in the form of relatively short and substantially straight members. The ribs 23 are interconnected to form a network 27 with spaces between the ribs 23 of the network 27 thereby defining a plurality of apertures 34 through the screen 7. The sizes of the apertures 34 are adapted to prevent or reduce the through passage of solids 41 above a certain size which may otherwise flow to the pump impeller 3. Each rib 23 is connected with at least one other rib 23 in the network 27 and the region of connection between any two or more ribs 23 is termed a junction 26. The angle formed between at least two of the ribs 23 meeting at any junction 26 may be an obtuse angle. The screen 7 may include an axial shroud 8 extending from a perimeter of the screen 7. The shroud 8 may extend from a perimeter of the screen in an upstream direction. The shroud 8 may be configured to reside within an internal diameter of a pump intake such that the screen 7 will be positioned substantially normal to the superficial direction of flow in the pump intake.

Referring to FIG. 6, shown is an example embodiment of a prior art screen 7 where the angle formed between any two ribs 23 meeting at a junction is a right angle or substantially a right angle. These junctions 26 may be termed “T” junctions 26 or “cross” junctions 26 to reflect the shape of these junctions 26 owing to the 90° angles, or substantially 90° angles formed between the ribs 23.

Referring now to FIG. 7, shown is an embodiment of a screen 7 according to the present invention. The network 27 comprised of the interconnected plurality of ribs 23 extends from an internal support 28 to an external support 29. The external support 29 may be configured as a ring or a sheaf, such as a shroud 8, adapted to fit coaxially with the inner diameter of the pump inlet. The internal support 28 may be configured as a ring with a central aperture 33 therethrough.

As shown in FIG. 7, the network 27 of interconnecting ribs 23 may be organized in arrays arranged axially/circumferentially around the internal support 28. A first axial/circumferential array 30 may comprise a plurality of ribs 23 depending radially outward from the central aperture 33. A final axial/circumferential array 32 may comprise a plurality of ribs 23 depending radially inward from the external support 29. A further axial/circumferential array termed the second axial/circumferential array 31 may arranged between the first axial/circumferential array 30 and the final axial/circumferential array 32. The ribs 23 comprising the second array may connect at one end with ribs 23 from the first axial array 30 and at their other end with ribs 23 from the final axial/circumferential array 32, thereby interconnecting the axial/circumferential arrays. In other embodiments, additional further arrays may locate between the first axial/circumferential array 30 and the final axial/circumferential array 32, with each further axial/circumferential array being staged at a radial distance from the preceding axial/circumferential array and connected to the preceding axial/circumferential array and the succeeding axial array.

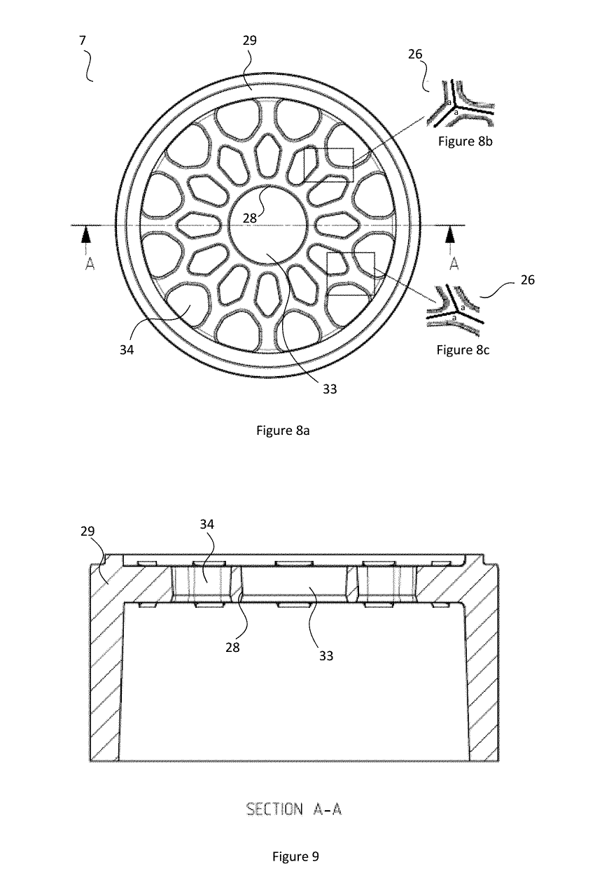

Otherwise stated, the first axial array 30 includes a plurality of ribs 23, each having a first end 24 and a second end 25. The first end 24 of each rib 23 of the first axial array 30 joins with the internal support 28, such that each rib 23 of the first axial array 30 depends outwardly from the internal support 28. The second end 25 of each rib 23 of the first axial array 30 joins with the first end 24 of at least one rib 23 of the second axial array 31 at a junction 26. In the embodiment of FIG. 8a, the second end 25 of each rib 23 of the first axial array 30 joins with the first ends 24 of two ribs 23 of the second axial array 31, thus forming a Y shaped junction 26, wherein the angle formed between the rib 23 of the first axial array 30 and either rib 23 of the second axial array 31 is obtuse.

The final axial array 32 includes a plurality of ribs 23, each having a first end 24 and a second end 25. The second end 25 of each rib 23 of the final axial array 32 joins with the external support 29, such that each rib 23 of the final axial array 32 depends inwardly from the external support 29. The first end 24 of each rib 23 of the final axial array 32 joins with the second end 25 of at least one rib 23 of the second axial array 31. In the embodiment of FIG. 8a, the first end 24 of each rib 23 of the final axial array 3232 joins with the second ends 4 of two ribs 23 of the second axial array 31, thus forming a Y shaped junction 26, wherein the angle formed between the rib 23 of the final axial array 32 and either rib 23 of the second axial array 31 is obtuse.

Referring now to FIG. 8b, shown is an exploded view of a junction 26 between a rib 23 of the first axial array 30 connected to two ribs 23 of the second axial array 31. The junction 26 is formed at a second end 25 of a rib 23 of the first axial array 30 and a first end 24 of two ribs 23 of the second axial array 31. In this junction 26, the three ribs 23 connect in a Y shape, with an obtuse angle being formed between any two ribs 23 in the junction 26. In particular, the angle (α) formed between the rib 23 of the first array and either of the ribs 23 of the second array 31 is obtuse, rather than at 90° as is typical for a prior art screen 7 such as that of FIG. 1.

Referring now to FIG. 8c, shown is an exploded view of a junction 26 between two ribs 23 of the second axial array 31 and a rib 23 of the final axial array 32. The junction 26 is formed at the second ends 4 of the ribs 23 of the second axial array 31 and a first end 24 of the rib 23 of the final axial array 32. In this junction 26, the three ribs 23 also connect in a Y shape, with an obtuse angle (α) being formed between either of the ribs 23 of the second array and the rib 23 of the final array.

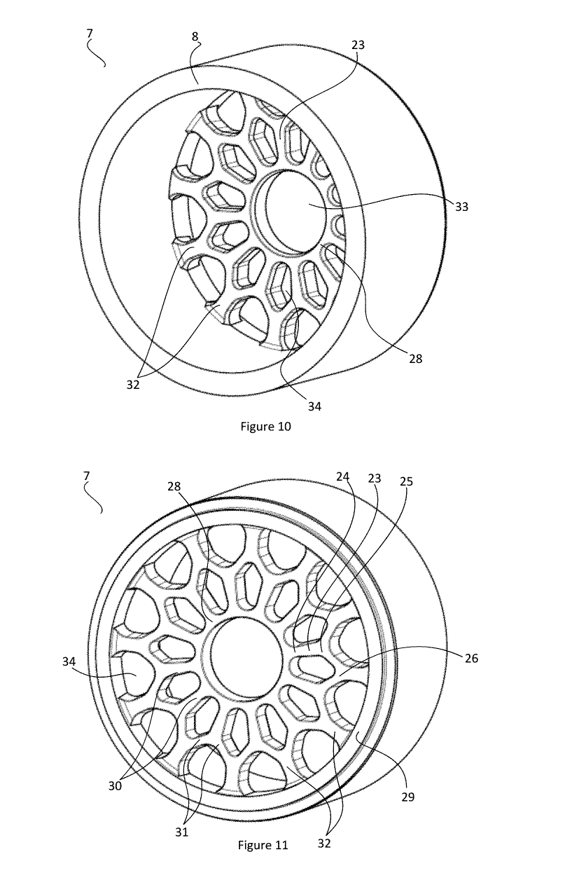

Referring to FIG. 9, shown is a cut-away view along section A-A of FIG. 8a demonstrating an example cross section of the ribs 23 as well as the axial shroud 8, which may taper in thickness towards the screen 7. Shown in FIGS. 10 and 11 are perspective views of the screen 7 from an upstream position and a down stream position respectively. Shown in FIG. 12 is a side view of the screen 7 showing that the network 27 of ribs 23 are contained within the internal diameter of the circumferential shroud 8.

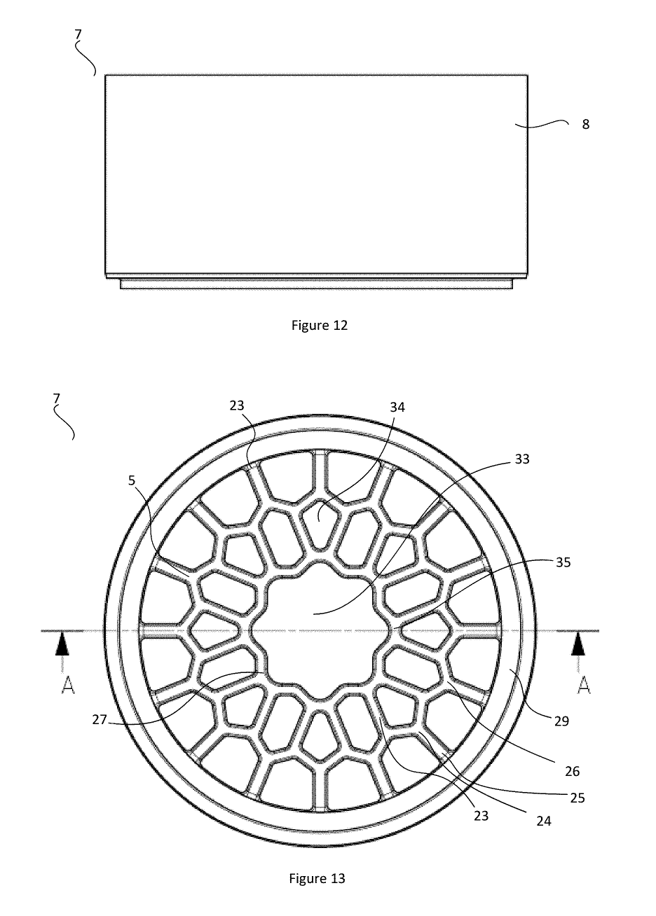

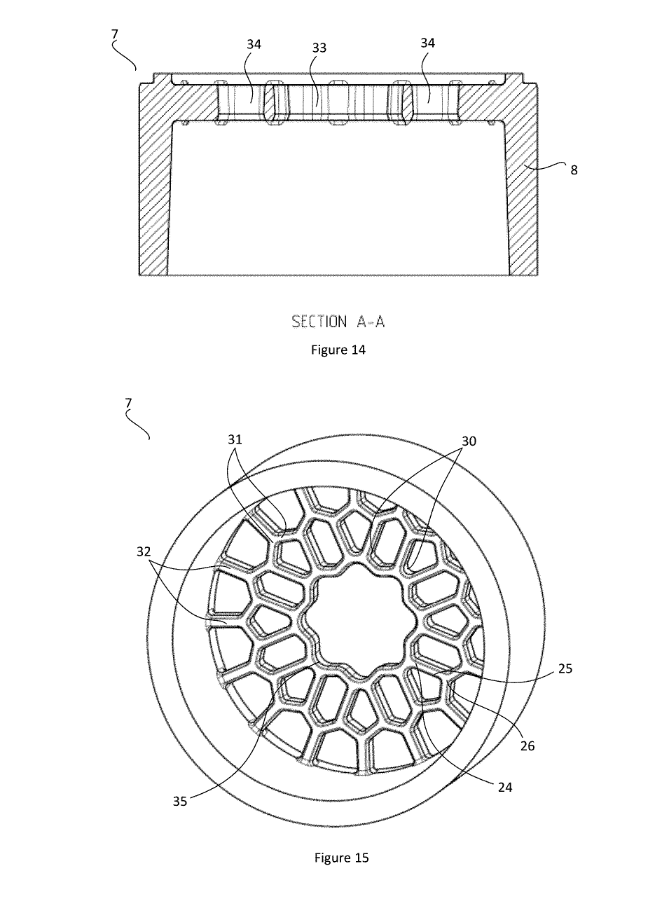

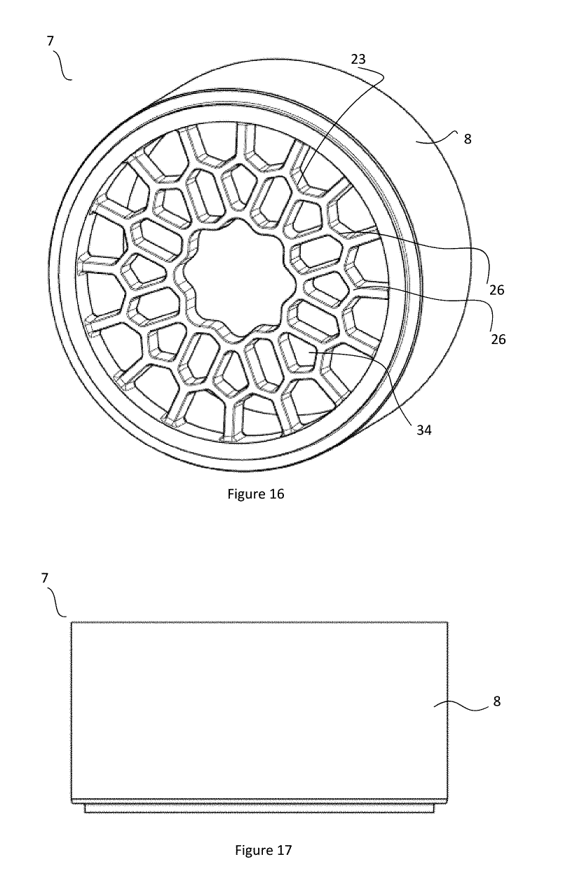

With reference to FIG. 13, shown is an alternative embodiment wherein the internal support 28 is configured in the shape of a star with a central aperture 33 similarly in the shape of the star/regular polygon. Specifically, the depicted embodiment is in the shape of a symmetrical eight point 35 star. As depicted, the star showed central aperture may have rounded points 35.

The first axial array 30 of FIG. 13 includes a plurality of ribs 23, each having a first end 24 and a second end 25. The first end 24 of each rib 23 of the first axial array 30 joins with the internal support 28, such that each rib 23 of the first axial array 30 depends outwardly from the internal support 28. In the depicted embodiment, two ribs 23 of the first axial array 30 join with the internal support 28 at the region of each point 35 of the star shaped internal support 28. The second end 25 of each rib 23 of the first axial array 30 joins with the first end 24 of at least one rib 23 of the second axial array 31 at a junction 26. In the embodiment of FIG. 13, the second end 25 of each rib 23 of the first axial array 30 joins with the first ends 24 of two ribs 23 of the second axial array 31, thus forming a Y shaped junction 26, wherein the angle formed between the rib 23 of the first axial array 30 and either rib 23 of the second axial array 31 is obtuse.

The final axial array 32 includes a plurality of ribs 23, each having a first end 24 and a second end 25. The second end 25 of each rib 23 of the final axial array 32 join with the external support 29, such that each rib 23 of the final axial array 32 depends inwardly from the external support 29. Specifically, each rib 23 of the final axial array 32 depends inwardly from the external support 29 in a generally radial direction. The first end 24 of each rib 23 of the final axial array 32 joins with the second end 25 of at least one rib 23 of the second axial array 31. In the embodiment of FIG. 13, the first end 24 of each rib 23 of the final axial array 32 joins with the second ends 25 of two ribs 23 of the second axial array 31, thus forming a Y shaped junction 26, wherein the angle formed between the rib 23 of the final axial array 32 and either rib 23 of the second axial array 31 is obtuse.

The central aperture 33 through the internal support 28 of the embodiments of FIG. 7 may define a passage for receiving a rotating shaft 4. The rotating shaft 4 may attach with a rotatable element adapted to rotate in advance of the screen 7 to reduce the size of solids in the pump inlet as hereinbefore described. In the alternative embodiment of FIG. 13, the internal support 28 is configured in the shape of a star with a central aperture 33 defining a passage for receiving a rotating shaft 4. By this arrangement, a gap 36 may exist between the cylindrical shaft 4and the space of the central aperture 33 formed by the points 35 of the star shaped internal support 28. The gap 36 between the rotating shaft 4 and the space of the central aperture 33 formed by the points 35 of the internal support 28 may act as apertures 34 preventing the through passage of solids 41 over a certain size, thus adding to the open area of the screen 7. The star shaped internal support 28 allows for an increased flow area over the internal support 28 of the prior art screen 7 of FIG. 6 while still controlling the size of particles flowing into the pump. The area within the central aperture 33 of FIG. 13 may be 1714 mm² compared with an area of 844 mm² within the central aperture 33 of the embodiment of FIG. 6, which represents a 94% improvement.

The network 27 arrangement of FIG. 13 leads to a different pattern of apertures 34 to the network 27 pattern of FIG. 7. The apertures 34 arranged adjacently around the internal support 28 of FIG. 13 are in the form of alternating hexagons and irregular diamonds. If further axial arrays were provided between the second axial array 31 and the final axial array 32, this pattern of apertures 34 may be repeated at a radial displaced intervals from the apertures 34 adjacent to the internal support 28.

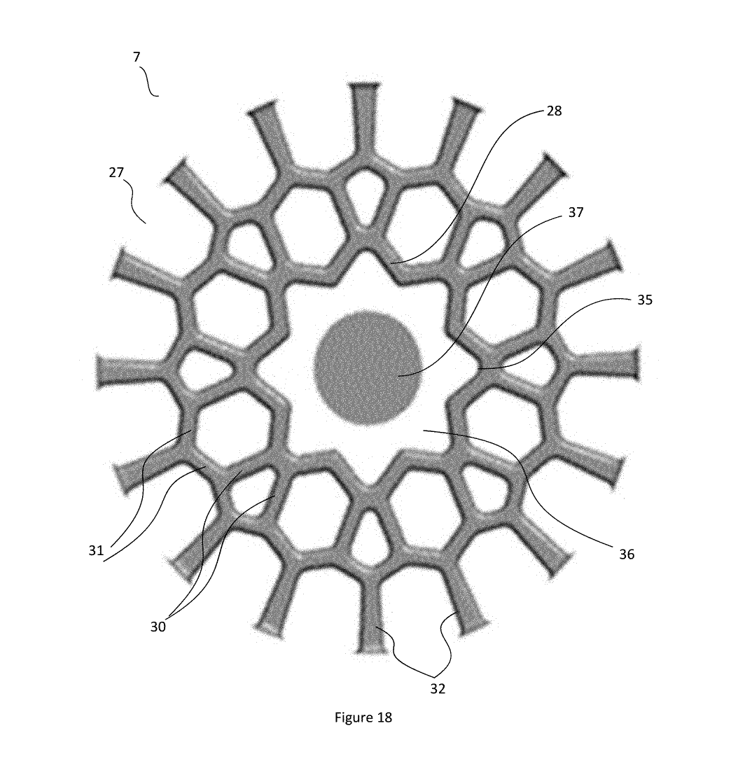

Referring to FIG. 14 shown is a cut-away view along section A-A of FIG. 13 demonstrating an example cross section of the ribs as well as the axial shroud 8. Shown in FIGS. 15 and 16 are perspective views of the embodiment of FIG. 18 from an upstream and down stream position respectively, whereas FIG. 17 shows a side view.

Referring now to FIG. 18, shown is a network 27 similar to that of FIG. 13 but disembodied from the external support 29. FIG. 18 provides an indication of the position of the rotating shaft 4 through the central aperture 33 of the internal support 28, showing the gaps 36 between the rotating shaft 4 and the indents of the central aperture 33.

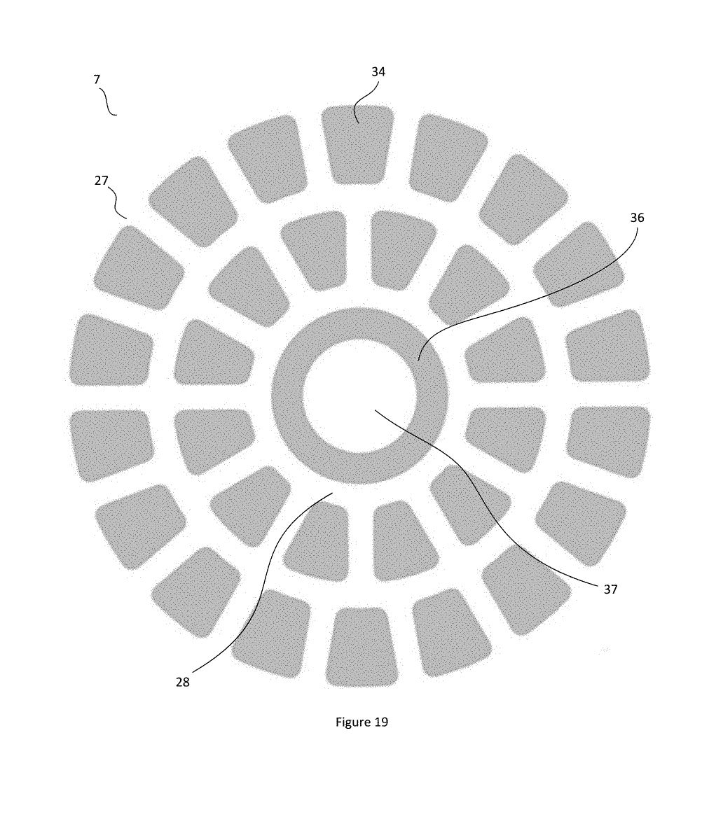

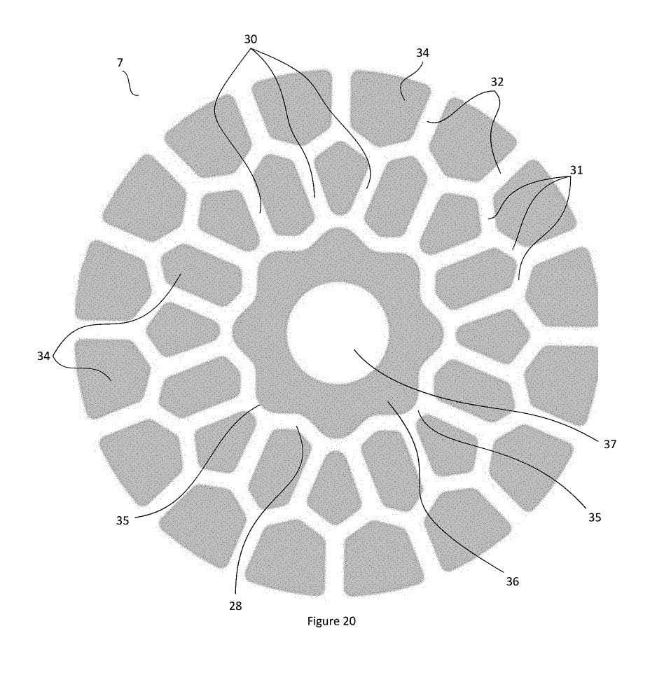

The embodiments of FIGS. 13 and 18 may provide a screen 7 with a greater percentage of open area compared to the screen 7 of embodiments depicted in FIG. 7. Similarly, the screen 7 of FIGS. 13 and 18, as well as the screen 7 of FIG. 7 may provide a greater percentage of open area compared with the prior art screen 7 of FIG. 6. The provision of a screen 7 with a higher open area may reduce the pressure loss of a fluid flowing through the screen 7, thus reducing the NPSH required by a pump with the screen 7 installed in the pump inlet. FIGS. 19 and 20 compare the open area of the screens 1 of FIGS. 7 and 13 respectively, with the shaded portions representing the open areas e.g. the apertures 34. The increase in open area may be achieved while still providing the same or similar sized apertures 34, thus increasing flow through the screen 7 whilst still protecting the pump 2 from over-sized solids 41. Providing this increase to the open area may allow thicker ribs 23 to be used which may increase the strength and robustness of the screen 7. The increase in open area may improve the NPSH of the pump. Furthermore, the larger apertures 34 toward the radial periphery of the screen 7 and the associated increase in flow therethrough may serve to improve the flushing of solids 41 through the screen which may reduce the buildup of solids 41 on the screen 7.

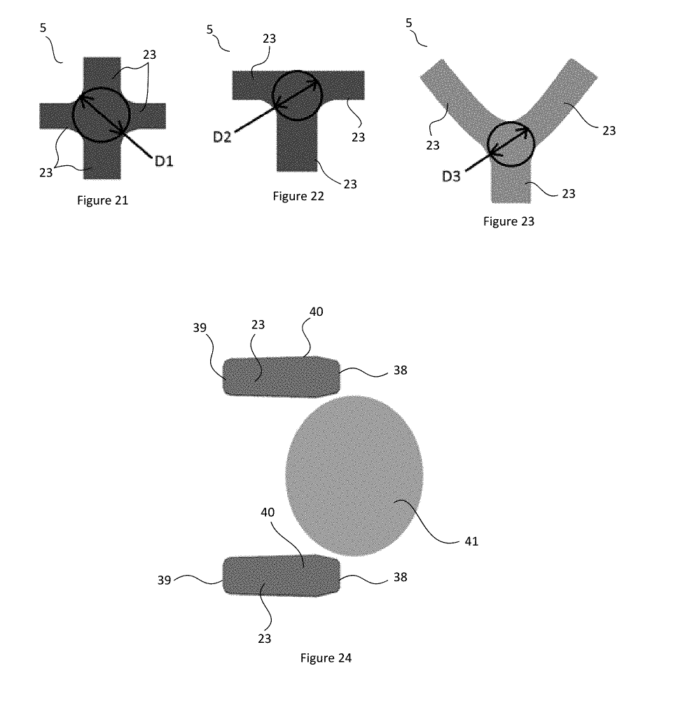

The embodiments of screens 7 herein described include a plurality of junctions 26 between ribs 23, where at least two of the ribs 23 involved in each of the junction 26 meet at an obtuse angle. In the depicted embodiments, any rib 23 joining with a rib 23 belonging to an axial array further displaced from the internal support 28 in the radial direction will meet at an obtuse angle. For example, any rib 23 of the first axial array 30 joining with a rib 23 from the second axial array 31 will meet at an obtuse angle. Similarly, any rib 23 of the second axial array 31 joining with a rib 23 of the final axial array 32 will meet at an obtuse angle. By this arrangement, the structural quality of the junctions 26 are improved compared to the prior art screen 7 of FIG. 6, wherein the junctions 26 involve ribs 23 meeting at 90°. When the screens 7 are cast from liquid metal, the T-shaped or cross-shaped junctions 26 of the prior art screen 7 result in a relatively high mass of metal at that junction 26 that takes longer than the surrounding areas to cool down, which in turn results in increased porosity which may reduce the strength and wear life of the screen 7. In contrast, the junctions 26 of the screens 7 according to the present invention result in a lower mass, as the “Y” shape of the junction 26 allows for a smaller junction 26 region between ribs 23 as may be noted by the smaller radii of the junction 26 in FIG. 23 compared with FIGS. 21 and 22, where D3<D2<D1. This in turn produces a junction 26 that takes less time to cool down and cast compared to the prior art junctions 26, leading to a screen 7 that may display increased strength and wear life.

FIGS. 21 and 22 show a T and cross shaped prior art junction 26 respectively, whereas FIG. 23 shows a Y shaped junction 26 consistent with the present invention where at least two of the ribs 23 involved meet at an obtuse angle. FIGS. 21 and 22 display the greater diameter and hence mass at the junction 26. In contrast, the Y shaped junction 26 of FIG. 23 shows a reduced diameter and hence mass at the junctions 26, allowing the part to cool at an even rate during the casting process.

Referring now to FIG. 24, shown is a schematic cutaway view of a solid 41 entering an aperture, showing two ribs 23 in profile. The ribs 23 include an upstream periphery 38 in the upstream direction of flow, and a downstream periphery 39 in the down stream direction of flow towards a pump. The ribs 23 may include a region of maximum thickness 40 between the upstream periphery 38 and the down stream periphery. The thickness of the rib may taper from the region of maximum thickness 40 towards the upstream periphery 38. The thickness of the rib may also taper from the region of maximum thickness 40 towards the downstream periphery 39. By this arrangement, the ribs 23 may define a streamlined profile that reduced the drag coefficient for liquid flowing through the screen 7. The upstream periphery 38 may be configured with a substantially blunt or flat profile orientated substantially normal to the direction of fluid flow in the pump intake. Similarly, the downstream periphery 39 may be configured with a substantially blunt or flat profile orientated substantially normal to the direction of fluid flow in the pump intake.

The region of maximum thickness 40 may occur nearer to the upstream periphery 38 than the downstream periphery 39, at about 15% to about 25% of the distance between the upstream periphery 38 and the downstream periphery 39. The region of maximum thickness 40 may occur at about 20% of the distance between the upstream periphery 38 and the downstream periphery 39.

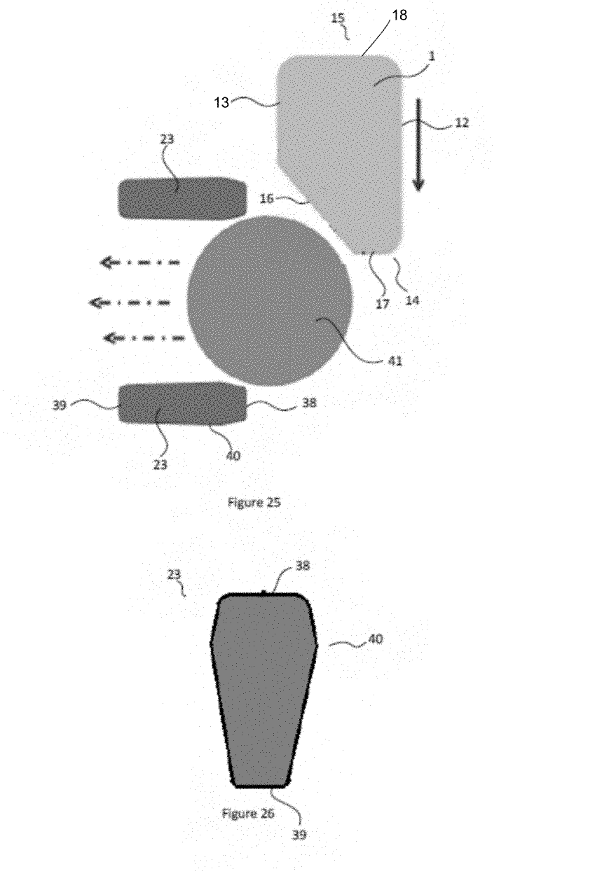

Referring to FIG. 25, shown is a schematic cutaway view similar to that of FIG. 25, but also showing a rotatable element 1 in cross section moving in the direction of the arrow. As depicted in FIG. 25, the chamfered surface 16 may impart a shearing action on solids 41 caught on the screen 7, and may thereby improve the breaking-up of such solids 41. The action of the trailing side 15 including the rearward surface 18 moving across the screen 7 may also act to apply break-up a suspended solid 41 caught on the screen 7. The chamfered surface 16 of the rotatable member 1 may also impart a substantially streamlined aerofoil shape to the rotatable member, which may also induce fluid flow toward the impeller and thus may lower the NPSHr of the pump 2.

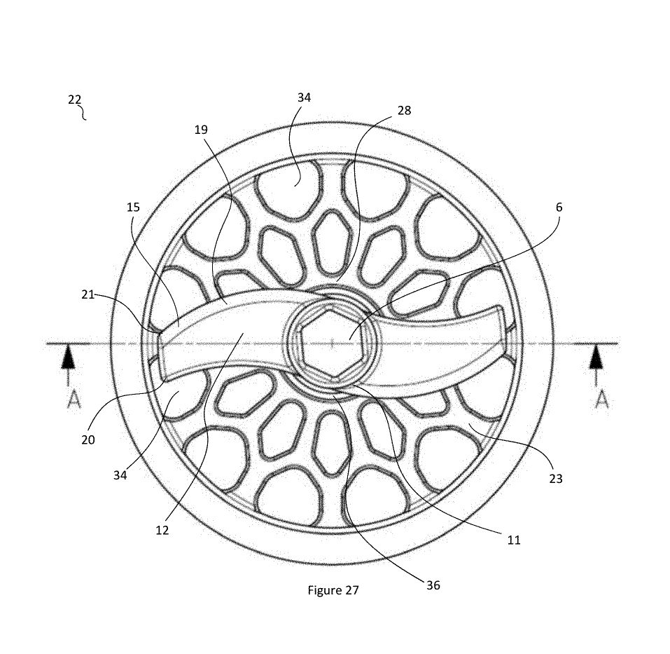

FIG. 26 shows a cross section view of a rib 23, demonstrating the transition from the blunt surface of the upstream periphery 38, with an increasing thickness towards the region of maximum thickness 40, and decreasing in thickness towards the blunt profile of the downstream periphery 39.

Referring now to FIGS. 27 to 32, shown are example embodiments of an assembly 22 according to the present invention, including the rotatable member 1 of FIGS. 2 to 5 with the screen of FIGS. 7 to 12. FIG. 26 shows a front view of the assembly from an upstream position showing the orientation of the rotatable member 1. FIG. 27 shows a cross section view of the assembly 22 taken along A-A of FIG. 26, demonstrating the position of the rotatable element 1 relative to the screen 7. The embodiment of FIG. 27 shows the rotatable element 1 as a monolithic design, inclusive of the locking nut 6. Such a monolithic design may facilitate the easy mounting and dismounting of the rotatable element 1 to the shaft 4. In other embodiments, the locking nut 6 may be separate to the rotatable element 1.

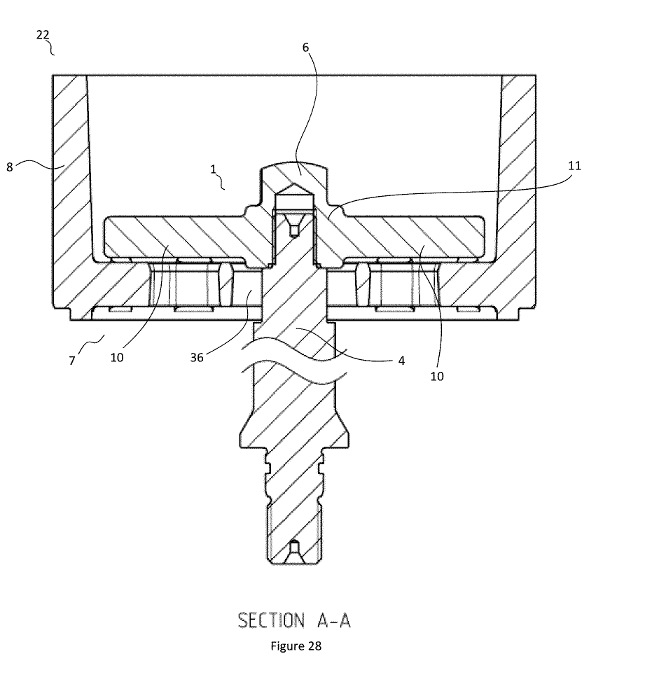

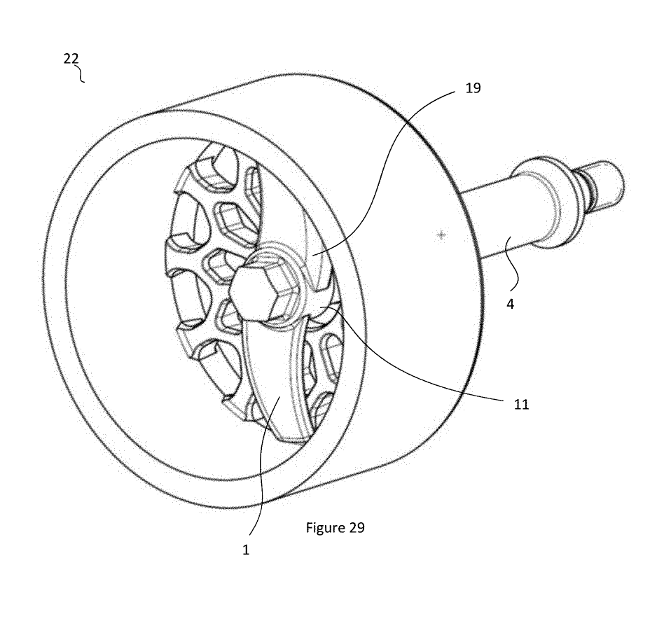

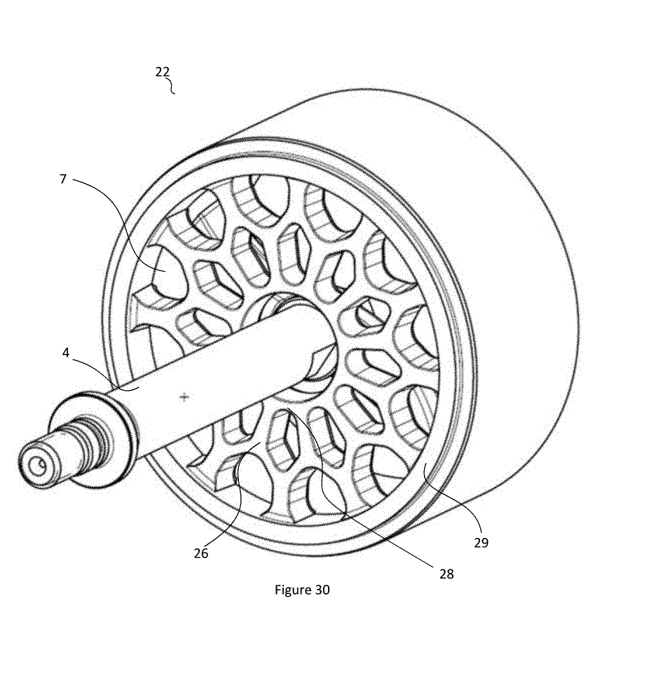

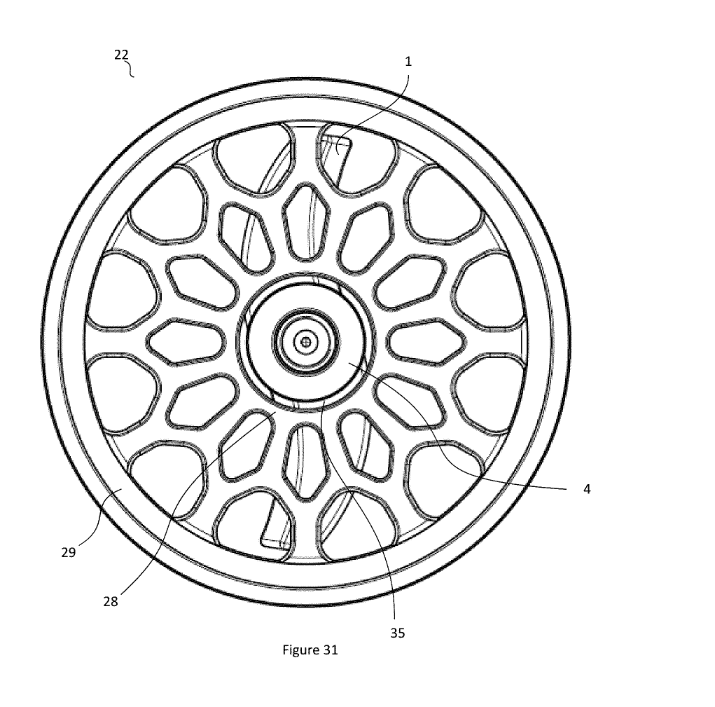

FIGS. 28 and 29 provide perspective views of the assembly from an upstream and downstream position respectively. FIG. 30 provides a back view of the assembly from a downstream position whereas FIG. 31 provides a side view of the assembly.

Many modifications will be apparent to those skilled in the art without departing from the scope of the present invention.

1-50. (canceled)

51. An assembly to receive an incoming fluid, to reduce the size of suspended solids in the incoming fluid to generate an output fluid, and to provide the output fluid to a pump, the assembly comprising:
a rotatable element having at least two arm members extending generally radially from a central hub; and
a screen positioned between the pump and the rotatable element, wherein the pump drives fluids having the suspended solids through the screen, and wherein the rotatable element is operable to shear at least a portion of the suspended solids going through the screen and reduce their sizes when one of the at least two arm members moves adjacent the screen.

52. The assembly according to claim 51, wherein each of the at least two arm members include opposed upstream and downstream sides, a leading side facing a first direction, and an opposed trailing side facing away from the first direction, wherein the leading side follows a curvature along a radial direction of the leading side such that the leading side curves inwardly towards the trailing side.

53. The assembly according to claim 51, wherein the trailing side includes a curvature along a radial direction of the trailing side such that the trailing side curves outwardly from the leading side.

54. The assembly according to claim 51, wherein the rotatable element is rotatable in a first direction about a rotation axis, wherein the at least two arm members include a leading side facing in the first direction, the leading side having a peripheral edge distal from the rotation axis; and a trailing side facing away from the first direction, the trailing side having a peripheral edge distal from the rotation axis, wherein the leading side includes a curvature relative to the radial extension of the arm member such that the leading side is generally concave relative to a radial line Y-Y extending from the rotation axis through the peripheral edge of the trailing side.

55. The assembly according to claim 54, wherein the trailing side includes a curvature relative to the radial extension of the arm member such that the trailing side is generally convex relative to a radial line extending from the rotation axis through the peripheral edge of the leading side.

56. The assembly according to claim 52, wherein the curvature of the leading side is continuous from a region proximal to the central hub to a region distal from the central hub.

57. The assembly according to claim 52, wherein the leading side includes a chamfered surface proximal to the downstream side and a forward surface proximal to the upstream side, wherein the chamfered surface is configured to incline towards the trailing side.

58. The assembly according to claim 57, wherein the chamfered surface is configured to incline towards the trailing side at an angle of between about 40° and about 60°.

59. The assembly according to claim 57, wherein the forward surface is substantially normal to the first direction.

60. The assembly according to claim 52, wherein the trailing side includes a rounded surface proximal to the upstream side and a rearward surface proximal to the downstream side.

61. The assembly according to claim 60, wherein the rounded surface includes a curvature smoothly transitioning between the rearward surface and the upstream surface such that the rounded surface encompasses an edge of the trailing side proximal to the upstream side.

62. The assembly according to claim 51, wherein the screen includes apertures sized to resist the passage therethrough of suspended solids above a maximum size.

63. The assembly according to claim 62, wherein the screen includes a shroud attached to a perimeter of the screen, the shroud adapted to seat within an inner diameter of an intake of the pump.

64. The assembly according to claim 51, wherein the screen comprises a plurality of ribs interconnected to form a network thereby defining a plurality of apertures, wherein the network includes a plurality of junctions formed by at least two ribs meeting at an obtuse angle.

65. The assembly according to claim 64, wherein the network comprises interconnected axial arrays of ribs, the network extending between an internal support and an external support, wherein the plurality of ribs are arranged into:
a first axial array of ribs connected to and arranged around an external perimeter of the internal support; and,
a final axial array of ribs connected to and arranged around an internal perimeter of the external support.

66. The assembly according to claim 64, wherein the arrangement of the plurality of ribs further includes one or more further axial arrays or ribs arranged successively at an increasing radial distance from the first axial array,

67. The assembly according to claim 65, wherein the internal support is configured in the shape of a ring defining a central aperture therethrough, wherein the central aperture is configured to receive a rotating shaft.

68. The assembly according to claim 65, wherein the internal support is configured in the shape of a star defining a central aperture therethrough, wherein the central aperture is configured to receive a rotating shaft.

69. An apparatus in fluid communication with a pump, the apparatus comprising:
a shroud adapted to fit coaxially with an inner diameter of an inlet of the pump to receive fluid flows having solids suspended therein;
a rotating member rotatable in the shroud and having a hub and an arm, the arm having a downstream side, a forward surface, and a chamfer surface connecting the downstream side to the forward side; and
a screen having a plurality of apertures and a plurality of internal supports, the screen having an upstream periphery facing toward the downstream side of the rotating member, wherein the plurality of apertures are sized to permit solids in the fluid flows within a size limit to pass the screen and wherein the forward surface of the rotating member and the upstream periphery are distanced to allow the rotating member to break apart solids greater than the size limit, the chamfer surface of the rotating member aiding the forward surface of the rotating member to break apart the solids.

70. A pump assembly comprising:
an impeller rotatable about a main shaft, the impeller extending a rotatable shaft coaxial with the main shaft;
an inlet to receive fluids having solids suspended therein, the inlet providing the fluids to the impeller;
a shroud adapted to fit coaxially with an inner diameter of the inlet to receive the fluids;
a rotating member connected to the rotatable shaft and rotatable in the shroud, the rotating member having an arm member having a downstream side, a forward surface, and a chamfer surface connecting the downstream side to the forward side; and
a screen having a plurality of apertures and a plurality of internal supports, the screen having an upstream periphery facing toward the downstream side of the rotating member, wherein the plurality of apertures are sized to permit solids in the fluids within a size limit to pass the screen and wherein the forward surface of the rotating member and the upstream periphery are distanced to allow the rotating member to break apart solids greater than the size limit, the chamfer surface of the rotating member aiding the forward surface of the rotating member to break apart the solids.
